(19) United States
(12) Patent Application Publication
(10) Pub. No.: US 2018/0182369 A1
(43) Pub. Date: Jun. 28, 2018

(54) METHOD FOR OBTAINING A POROUS ACOUSTIC LAYER AND POROUS ACOUSTIC LAYER THUS OBTAINED

(71) Applicant: Airbus Operations SAS, Toulouse (FR)

(72) Inventors: Florian RAVISE, SAINT-HERBLAIN (FR); Florent MERCAT, TOULOUSE (FR)

(21) Appl. No.: 15/848,818

(22) Filed: Dec. 20, 2017

(30) Foreign Application Priority Data
Dec. 23, 2016 (FR) 1663297

(51) Int. Cl. G10K 11/168; B64C 7/02; B32B 15/14; B32B 15/02; B32B 7/04; B32B 5/02

(52) U.S. Cl. CPC G10K 11/168; B64C 7/02; B32B 15/14; B32B 15/02; B29K 2105/20; B32B 5/024; B32B 2305/026; B32B 2307/10; B32B 7/04

(57) ABSTRACT

A method for obtaining a porous acoustic layer, comprising a step of deposition of a plurality of fiber wicks arranged in at least two secant directions, the width, the orientation and/or the spacing of the fiber wicks being determined as a function of the open surface ratio desired for each zone of the porous acoustic layer. A porous acoustic layer obtained according to the method, as well as an acoustic panel comprising at least one porous layer, are also disclosed.

### CROSS-REFERENCES TO RELATED APPLICATIONS

This application claims the benefit of the French patent application No. 1663297 filed on Dec. 23, 2016, the entire disclosures of which are incorporated herein by way of reference.

### BACKGROUND OF THE INVENTION

The present invention relates to a method for obtaining a porous acoustic layer and to a porous acoustic layer thus obtained.

An aircraft comprises many acoustic panels to deal with the various noise sources. According to an embodiment illustrated by FIG. 1, an acoustic panel 10 comprises a porous acoustic layer 12 on a first face, a reflecting layer 14 on a second face and a cellular structure 16 interposed between the porous acoustic layer 12 and the reflecting layer 14. As a variant, the acoustic panel comprises two cellular structures superposed and inserted between the porous layer 12 and the reflecting layer 14, separated by a porous acoustic layer called septum.

According to a first embodiment, the porous acoustic layer is obtained from a sheet of composite material which is perforated by using a laser machining technique for example. According to this first embodiment, the openings have a constant diameter which takes a value of between 0.6 and 2 mm.

With such opening diameter values, the porous acoustic layer has a nonlinear behavior, strongly dependent on the level of the noise. Furthermore, such openings induce a parasitic drag which affects the aerodynamic performance levels of the acoustic panel.

The parasitic drag can be improved by producing openings with a diameter less than 0.1 mm. However, it is not possible to produce by machining openings with a diameter less than 0.3 mm in a sheet several millimeters thick.

According to a second embodiment, the porous acoustic layer is a ply woven from evenly spaced metal wires called “wire mesh”. This woven ply makes it possible to obtain openings with sections of a diameter less than 0.1 mm. However, this woven ply is too supple to be able to be applied to the cellular structure. Furthermore, the open surface ratio of the woven ply is uniform and constant over all the surface of the woven ply.

According to a third embodiment described in the document FR2823590 and illustrated by FIG. 1, the porous acoustic layer 12 comprises a sheet 18 which has a plurality of openings 20 and a woven ply 22 inserted between the perforated sheet 18 and the cellular structure 16. The perforated sheet 18 has a structural function, stiffening the woven ply 22.

The openings 20 produced in the sheet 18 have oblong forms and are arranged in several rows and several columns. According to this third embodiment, the openings have a constant diameter and the sections of the interstices between the wires of the woven ply 22 are constant and uniform.

In all the embodiments described, the geometry of the porous acoustic layer is constant. Now, the local conditions (position, noise level, flow velocity, geometry of the duct, etc.) vary along the acoustic panel and, with such porous acoustic layers, the acoustic performance of the panel is not optimized over all of the panel.

### SUMMARY OF THE INVENTION

The present invention aims to remedy all or some of the drawbacks of the prior art.

To this end, the subject of the invention is a method for obtaining a porous acoustic layer, characterized in that it comprises a step of deposition of a plurality of fiber wicks distributed in at least two series oriented in two secant directions to delimit between the fiber wicks openings, the fiber wicks having a width, an orientation and/or a spacing that are determined as a function of an open surface ratio desired for each zone of the porous acoustic layer.

Thus, it is possible to modulate the open surface ratio zone by zone over all the surface of the porous acoustic layer and to adjust the dimensions of the openings as a function of the acoustic treatment desired for each zone.

According to another feature, the width, the orientation and/or the spacing of the fiber wicks are determined as a function of the mechanical reinforcement desired for the porous acoustic layer.

According to one configuration, the fiber wicks of a first series are oriented in a first direction, the fiber wicks of a second series are oriented in a second direction at right angles to the first direction and the fiber wicks of a third series are oriented in an oblique third direction, secant to the first and second directions and parallel to a direction of the forces absorbed by the porous acoustic layer.

According to a first embodiment, the wicks have a spacing less than 0.1 mm. With such a spacing, the openings between the fiber wicks induce a low parasitic drag.

According to a second embodiment, the obtention method comprises a step of deposition of a woven ply having a pitch less than 0.1 mm. Preferentially, the method comprises a first step of deposition of the woven ply and a second step of deposition of the fiber wicks on the woven ply, the fiber wicks and the woven ply being produced in materials configured to allow the fiber wicks to adhere directly to the woven ply.

According to another feature, the method for obtaining a porous acoustic layer comprises a step of consolidation of the fiber wicks carried out simultaneously with the step of deposition of the fiber wicks.

Another subject of the invention is a porous acoustic layer obtained, characterized in that it comprises a plurality of fiber wicks distributed in at least two series oriented in two secant directions to delimit between the fiber wicks openings, the fiber wicks having a width, an orientation and/or a spacing that are determined as a function of an open surface ratio desired for each zone of the porous acoustic layer.

According to another feature, the width, the orientation and/or the spacing of the fiber wicks are determined as a function of the mechanical reinforcement desired for the porous acoustic layer.

According to a first embodiment, the wicks have a spacing less than 0.1 mm.

According to a second embodiment, the porous acoustic layer comprises a woven ply having a pitch less than 0.1 mm.

Another subject of the invention is an acoustic panel comprising at least one porous acoustic layer according to the invention.

### BRIEF DESCRIPTION OF THE DRAWINGS

Other features and advantages will emerge from the following description of the invention, the description being given purely as an example, in light of the attached drawings in which:

FIG. 1 is a perspective view of a part of an acoustic panel which illustrates an embodiment of the prior art,

FIG. 2 is a perspective view of a part of an acoustic panel which illustrates an embodiment of the invention,

FIG. 3 is a plan view of a woven ply,

FIG. 4 is a plan view of a woven ply to which are added fiber wicks which illustrates an embodiment of the invention,

FIGS. 5 and 6 are diagrams which illustrate the steps of laying of a woven ply and of a plurality of fiber wicks of a method for obtaining a porous acoustic layer according to the invention,

FIGS. 7A and 7B are plan views which illustrate different arrangements of fiber wicks of a porous acoustic layer.

### DETAILED DESCRIPTION OF THE PREFERRED EMBODIMENTS

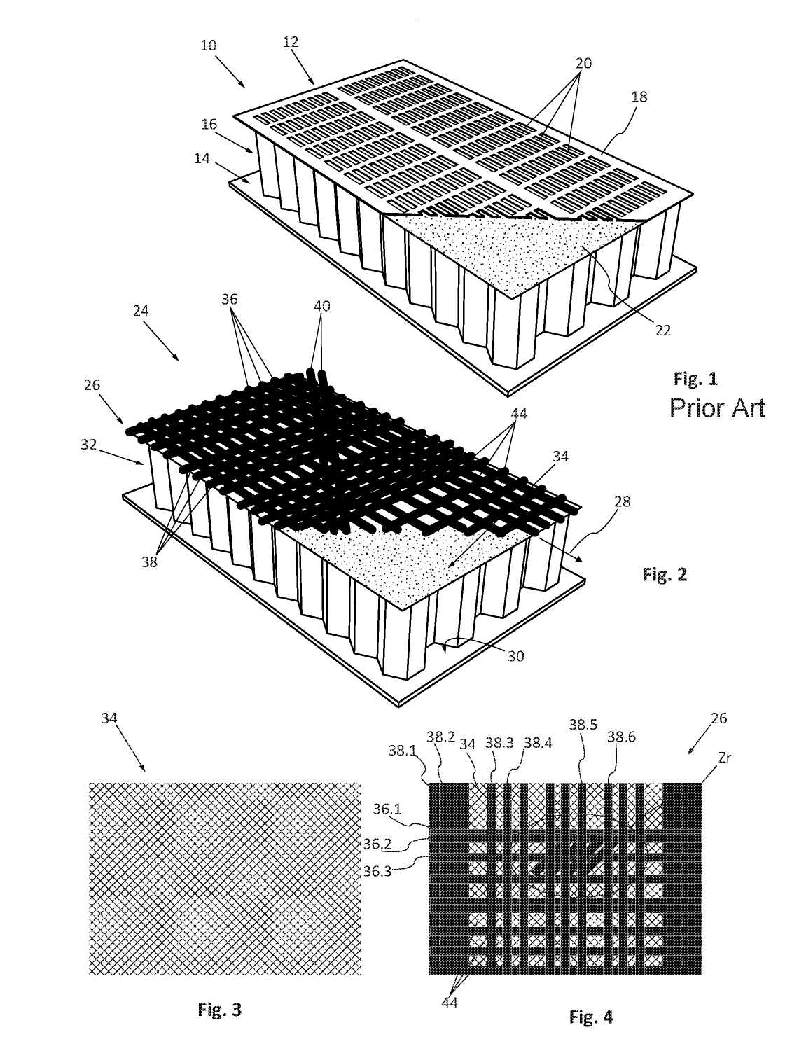

As illustrated in FIG. 2, an acoustic panel 24 comprises a porous acoustic layer 26 on a first face, in contact with an air flow represented by the arrow 28, a reflecting layer 30 on a second face and at least one cellular structure 32 inserted between the porous acoustic layer 26 and the reflecting layer 30.

According to one embodiment, the acoustic panel 24 comprises just one cellular structure 32. As a variant, the acoustic panel 24 comprises two cellular structures 32 superposed and separated by a porous acoustic layer.

As an example, the acoustic panel 24 is used to form an air intake of an aircraft nacelle.

According to one embodiment, the porous acoustic layer 26 comprises at least one woven ply 34 and a plurality of fiber wicks 36, 38, 40 positioned on a first face 42 of the woven ply 34 and oriented in at least two secant directions.

According to one embodiment, the woven ply 34 is made of thermoplastic resin, such as polyetheretherketone for example, designated by the acronym PEEK.

The woven ply 34 comprises warp and weft wires oriented in two directions at right angles and evenly spaced, with a pitch less than or equal to 0.3 mm. Preferentially, the pitch between the wires of the woven ply 34 is less than 0.1 mm.

Obviously, the invention is not limited to this embodiment for the woven ply 34.

For the present application, a fiber wick comprises one or more fibers attached to one another. The length of a fiber wick 36, 38, 40 corresponds to the largest dimension of the fiber wick. When a fiber wick 36, 38, 40 is pressed against the woven ply 34, the width of the fiber wick 36, 38, 40 corresponds to the dimension of the fiber wick parallel to the woven ply 34 and at right angles to the length. The thickness of the fiber wick 36, 38, 40 corresponds to the dimension of the fiber wick at right angles to the woven ply 34 and to the length.

When a fiber wick 36, 38, 40 comprises several fibers, the latter are arranged so as to form a strip with a width significantly greater than the thickness.

A fiber wick 36, 38, 40 has a width of between 1 mm and several millimeters.

According to one embodiment, the fibers of the wicks are made of carbon and pre-impregnated with a thermoplastic resin, such as polyetheretherketone for example, designated by the acronym PEEK, or polyetherimide, designated by the acronym PEI.

According to one embodiment, the fiber wicks 36, 38, 40 are pre-impregnated with a resin whose transformation temperature is less than or equal to that of the resin of the woven ply 34.

Thus, by way of example, the use of a polyetherimide resin for the fiber wicks 36, 38, 40 makes it possible to limit the risks of degradation of the woven ply 34 produced in polyetheretherketone, the melting point of the polyetheretherketone resin of around 342° C. being above the range of transformation temperatures of the polyetherimide resin of between 217° C. and 320° C.

According to another feature of the invention, the materials of the woven ply 34 and of the fiber wicks 36, 38, 40 are chosen such that the fiber wicks 36, 38, 40 adhere directly to the woven ply 34. Thus, the fiber wicks 36, 38, 40 no longer move after having been deposited on the woven ply 34.

According to one arrangement, the fiber wicks 36 of a first series are oriented in a first direction, for example parallel to the axis of the nacelle, the fiber wicks 38 of a second series are oriented in a second direction at right angles to the first direction, for example in planes at right angles to the axis of the nacelle, and the fiber wicks 40 of a third series are oriented in an oblique third direction, secant to the first and second directions.

For each series, the fiber wicks are distributed according to a pitch (spacing between two consecutive fiber wicks) which varies from 0 mm to several millimeters. Thus, for each series, the pitch can be constant or variable.

Thus, as an example, for the first series, the pitch between two fiber wicks 36.1 and 36.2 is zero and the pitch between two fiber wicks 36.2 and 36.3 is of the order of a few tenths of millimeters.

As an example, for the second series, the pitch between two fiber wicks 38.1 and 38.2 is zero, the pitch between two fiber wicks 38.3 and 38.4 is of the order of a few tenths of millimeters and the pitch between two fiber wicks 38.5 and 38.6 is of the order of a millimeter.

The fiber wicks of one and the same series may not have the same dimensions. Thus, the fiber wick 36.1 has a width significantly less than that of the fiber wick 36.2.

Whatever the arrangement, the porous acoustic layer 26 comprises at least two series of fiber wicks 36, 38 oriented in two secant directions to delimit between the fiber wicks openings 44 with dimensions which can vary from around a tenth of a millimeter to several millimeters, the spacing, the width and/or the orientation of the fiber wicks 36, 38, 40 being determined as a function of the acoustic performance levels sought.

The woven ply 34 is optional. It is applied according to the maximum parasitic drag acceptable for the use. In the case of an aircraft, it is possible to consider not providing any woven ply 34 if the porous acoustic layer 26 comprises openings 44 whose diameter is less than 0.1 mm.

Thus, it is possible to modulate the open surface ratio zone by zone, over all the surface of the porous acoustic layer, and to adjust the dimensions of the openings 44 as a function of the acoustic treatment desired for each zone. Consequently, according to the invention, the dimensions and orientations of the perforations, as well as the open surface ratio, are defined according to the local conditions (position, noise level, flow velocity, geometry of the duct, etc.) and the acoustic performance levels sought in order to optimize the acoustic treatment along the acoustic panel.

As an example, as illustrated in FIG. 7A, the porous acoustic layer 26′ comprises a first zone Z1 with an open surface ratio of the order of 60%, a second zone Z2 with an open surface ratio of the order of 30% and other zones Z3 to Z5 with an open surface ratio of the order of 70%.

As illustrated in FIG. 7B, the porous acoustic layer 26″ comprises a first zone Z1 with an open surface ratio of the order of 60%, zones Z2 and Z3 with an open surface ratio of 0% and zones Z4 and Z5 with an open surface ratio of the order of 30%.

According to another feature, the width, the orientation and/or the spacing of the fiber wicks 36, 38, 40 are determined as a function of the mechanical reinforcement desired, for example to reinforce certain zones of the porous acoustic layer 26 and/or to promote the absorption of the forces in a direction.

According to one embodiment, the fiber wicks 40.1 and 40.2 of the third series are oriented parallel to the main direction of the forces absorbed by the porous acoustic layer. As an example, the fiber wicks 40.1 and 40.2 are oriented in a 45° direction to promote the absorption of the forces oriented at 45° in relation to the axis of the nacelle.

According to another embodiment, the fiber wicks 40.1, 40.2 have lengths less than the dimensions of the porous acoustic layer 26 and do not extend from one edge to the other of the porous acoustic layer 26, in order to obtain a reinforcement zone Zr.

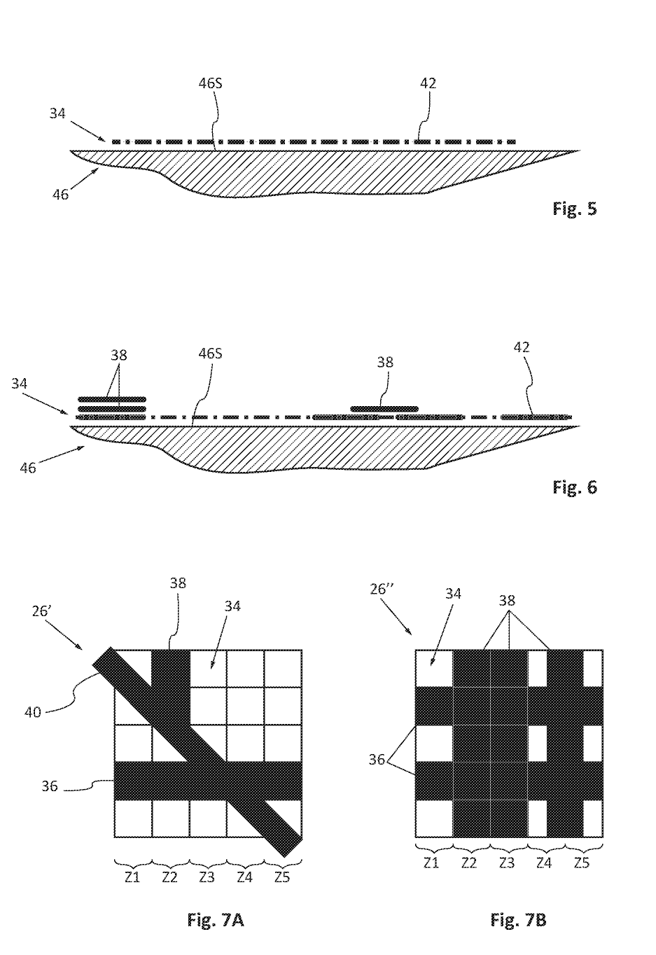

According to a first procedure illustrated by FIGS. 5 and 6, a method for obtaining a porous acoustic layer comprises a first step of deposition E1, on a deposition surface 46S of a rig 46 conformed according to the form of the acoustic panel desired, of fiber wicks 36, 38, 40 in at least two secant directions.

After the step of deposition E1 of the fiber wicks 36, 38, 40, the method comprises a step of consolidation E2 of the fiber wicks 36, 38, 40 to obtain a rigid porous acoustic layer 26. Preferentially, the step of consolidation E2 is carried out simultaneously with the step of deposition E1.

According to a second procedure, the method comprises a step of deposition Ep of a woven ply 34. Preferentially, the woven ply 34 is deposited on the deposition surface 46S prior to the step of deposition E1 of the fiber wicks 36, 38, 40. As a variant of this second procedure, the step of deposition Ep is carried out after the step of deposition E1 of the fiber wicks 36, 38, 40.

After the steps of deposition E1 of the fiber wicks 36, 38, 40 and Ep of the woven ply 34, the method comprises a step of consolidation E′2 of the fiber wicks 36, 38, 40 and a step of consolidation E′2p of the woven ply 34 in order to obtain a rigid porous acoustic layer 26.

According to a first variant, the step of consolidation E′2 of the fiber wicks 36, 38, 40 and the step E′2p of consolidation of the woven ply 34 are carried out simultaneously.

According to a second variant, the woven ply 34 is consolidated prior to the step of deposition E1 of the fiber wicks 36, 38, 40 and the step E′2 is carried out simultaneously with the step of deposition E1 of the fiber wicks 36, 38, 40 by an in-situ consolidation device.

According to a third procedure, the woven ply 34 on the one hand and the fiber wicks 36, 38, 40 on the other hand are deposited and consolidated separately. Consecutively, the woven ply 34 and the fiber wicks 36, 38, 40 are assembled by any appropriate means.

The step of deposition E1 of the fiber wicks 36, 38, 40 is carried out using a placement machine to deposit, on the first face of the woven ply 34 or on the deposition surface 46S, each fiber wick 36, 38, 40 according to a predefined arrangement. Thus, the dimensions and orientations of the fiber wicks and the spacing between two consecutively laid fiber wicks and the open surface ratio of the porous acoustic layer 26 are adapted over all the surface of the layer as a function of the desired acoustic performance level.

The fiber wicks are stored on at least one reel. The placement machine can comprise several reels with different fiber wick widths.

As an example, a first reel comprises a fiber wick with a width of the order of 1 mm and a second reel comprises a fiber wick with a width of the order of 6.35 mm.

When the porous acoustic layer 26 is produced, it is assembled with the other elements of the acoustic panel 24.

Depending on the configurations, it is possible to position the woven ply 34 between the fiber wicks 36, 38, 40 and the cellular structure 32 or to position the fiber wicks 36, 38, 40 between the woven ply 34 and the cellular structure 32.

According to one procedure, after the production of the porous acoustic layer 26, the junction between the cellular structure 32 and the porous acoustic layer 26 is obtained by polymerization.

According to the invention, it is possible to adapt the open surface ratio of the different zones of a porous acoustic layer as a function of the acoustic performance levels sought for each of these zones.

The open surface ratio can be adjusted as a function of the width of fibers 36, 38, 40, of the orientation of the fiber wicks 36, 38, 40 and/or of the spacing between the fiber wicks 36, 38, 40. The open surface ratio can also be adjusted as a function of the dimensions of the interstices of the woven ply 34.

According to another advantage, it is possible to adjust, zone by zone, the mechanical reinforcement of the porous acoustic layer 26.

According to another advantage, it is possible to leave a spacing less than 0.3 mm between the fiber wicks to thus obtain openings 44 with a section less than 0.1 mm². This dimension for the openings makes it possible to generate a low parasitic drag, to eliminate the woven ply 34 and to be able to position the acoustic panel in zones where an excessive parasitic drag is not tolerated.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for obtaining a porous acoustic layer, comprising a step of deposition of a plurality of fiber wicks distributed in at least two series oriented in two secant directions to delimit between the fiber wicks openings with dimensions which vary, the fiber wicks having at least one of a width, an orientation or a spacing, that is determined as a function of an open surface ratio desired for each zone of the porous acoustic layer to modulate the open surface ratio zone by zone.

2. The method for obtaining a porous acoustic layer according to claim 1, wherein the at least one of the width, the orientation or the spacing of the fiber wicks is determined as a function of the mechanical reinforcement desired for the porous acoustic layer.

3. The method for obtaining a porous acoustic layer according to claim 2, wherein the fiber wicks of a first series are oriented in a first direction, the fiber wicks of a second series are oriented in a second direction at right angles to the first direction and the fiber wicks of a third series are oriented in an oblique third direction, secant to the first and second directions and parallel to a direction of forces absorbed by the porous acoustic layer.

4. The method for obtaining a porous acoustic layer according to claim 1, wherein the wicks have a spacing less than 0.1 mm.

5. The method for obtaining a porous acoustic layer according to claim 1, further comprising a step of deposition of a woven ply having a pitch less than 0.1 mm.

6. The method for obtaining a porous acoustic layer according to claim 5, further comprising a first step of deposition of the woven ply and a second step of deposition of the fiber wicks on the woven ply, the fiber wicks and the woven ply being produced in materials configured to allow the fiber wicks to adhere directly to the woven ply.

7. The method for obtaining a porous acoustic layer according to claim 1, further comprising a step of consolidation of the fiber wicks carried out simultaneously with the step of deposition of the fiber wicks.

8. A porous acoustic layer obtained from the obtention method according to claim 1, comprising a plurality of fiber wicks distributed in at least two series oriented in two secant directions to delimit between the fiber wicks openings with dimensions which vary, the fiber wicks having at least one of a width, an orientation or a spacing, that is determined as a function of an open surface ratio desired for each zone of the porous acoustic layer in order to modulate the open surface ratio zone by zone.

9. The porous acoustic layer according to claim 8, wherein the at least one of the width, the orientation or the spacing of the fiber wicks is determined as a function of the mechanical reinforcement desired for the porous acoustic layer.

10. The porous acoustic layer according to claim 8, wherein the wicks have a spacing less than 0.1 mm.

11. The porous acoustic layer according to claim 8, comprising a woven ply having a pitch less than 0.1 mm.

12. An acoustic panel comprising at least one porous acoustic layer according to claim 8.
